(19) United States
(12) Patent Application Publication
(10) Pub. No.: US 2025/0080759 A1
(43) Pub. Date: Mar. 6, 2025

(54) BACKWARD REFERENCE UPDATING FOR VIDEO CODING

(71) Applicant: APPLE INC., Cupertino, CA (US)

(72) Inventors: Guoxin JIN, San Diego, CA (US); Yeqing WU, Cupertino, CA (US); Yunfei ZHENG, Santa Clara, CA (US); Dazhong ZHANG, Saratoga, CA (US); Dzung T. HOANG, Morgan Hill, CA (US); Felix C. FERNANDES, Saratoga, CA (US); Van Luong PHAM, San Diego, CA (US); Jiancong LUO, San Diego, CA (US); Yixin DU, Milpitas, CA (US); Hilmi Enes EGILMEZ, Santa Clara, CA (US); Alican NALCI, Cupertino, CA (US); Jun XIN, San Jose, CA (US); Hsi-Jung WU, San Jose, CA (US)

(21) Appl. No.: 18/794,601

(22) Filed: Aug. 5, 2024

Related U.S. Application Data
(60) Provisional application No. 63/632,870, filed on Apr. 11, 2024.
(60) Provisional application No. 63/580,471, filed on Sep. 5, 2023.

(51) Int. Cl. H04N 19/176; H04N 19/117; H04N 19/159; H04N 19/46; H04N 19/70; H04N 19/82

(52) U.S. Cl. CPC H04N 19/176; H04N 19/117; H04N 19/159; H04N 19/46; H04N 19/70; H04N 19/82

(57) ABSTRACT

Techniques are disclosed for coding video in applications where regions of video are inactive on a frame to frame basis. According to the techniques, coding processes update and reconstruct only a subset of pixel blocks of pixels within a frame, while other pixel blocks are retained from a previously coded frame stored in a coder's or decoder's reference frame buffer. The technique is called Backward Reference Updating (or “BRU”) for convenience. At a desired pixel block granularity, based on the activity between a current frame to be coded and its reference frame(s), BRU will only perform prediction, transform, quantization, and reconstruction on selected regions that are determined to be active. The reconstructed pixels in these active regions are directly placed onto a specified reference frame in memory instead of creating a new frame. Therefore, fewer memory transfers need to be performed.

### CLAIM FOR PRIORITY

The present application benefits from priority of U.S. patent application Ser. No. 63/632,870, filed Apr. 11, 2024 and entitled “Backward Reference Updating for Video Coding, and U.S. patent application Ser. No. 63/580,471, filed Sep. 5, 2023 and entitled “Backward Reference Updating for Video Coding,” the disclosures of which are incorporated herein in their entireties.

### BACKGROUND

The present disclosure relates to video coding and, in particular, to management of reference frames employed in predictive video coding applications where low latency, low memory bandwidth, and low power consumption are requirements.

There are many video coding application where low latency, low memory bandwidth and low power consumption properties are important. In one exemplary application, a user may extend display content of a first device (for example, a tablet computer) to a display device of a second device (e.g., a personal computer). In another example, displayed video of a first device (again, a tablet computer perhaps) is mirrored to another display (a smart television). Modern video conferencing applications support exchange of captured video and presentation content on a real-time basis. And, as a further example, displayable content generated from a first user device (example, a smartphone) may be transferred to a display of a second device (a display on a car) where an active user interface might be presented. In these examples, video coding may be applied to compress the video data that is shared between the devices and applications.

In circumstances where displayable content from one device is sent to another, it can occur that only a very small portion of displayable content changes on a frame-to-frame basis. For example, in an application where a user interface is generated by one device but displayed on another, an operator may move a cursor across otherwise static content. Thus, the cursor may be the only content that changes across a plurality of frames. Conventional video compression techniques compress frames in their entirety, which is inefficient for these circumstances, presenting challenges in terms of latency, complexity, and power, especially for frame content with high resolution, e.g., 4K or higher.

### BRIEF DESCRIPTION OF THE DRAWINGS

FIG. 1 illustrates a video exchange system according to an aspect of the present disclosure.

FIG. 2 is a functional block diagram of an encoding system according to an aspect of the present disclosure.

FIG. 3 is a simplified functional block diagram of a decoding terminal according to an aspect of the present disclosure.

FIG. 4 illustrates a video coding method according to an embodiment of the present disclosure.

FIG. 5 illustrates a video decoding method according to an embodiment of the present disclosure.

FIG. 6 illustrates a video coding method according to an embodiment of the present disclosure.

FIG. 7 illustrates a video decoding method according to an embodiment of the present disclosure.

FIG. 8 illustrates an exemplary frame that illustrates the phenomenon of available and unavailable regions.

FIG. 9 illustrates another exemplary frame that illustrates the phenomenon of available and unavailable regions.

FIG. 10 illustrates an exemplary frame that illustrates the phenomenon of available and unavailable regions.

FIG. 11 illustrates an exemplary frame that illustrates a relationship between the phenomenon of available and unavailable regions.

FIG. 12 exemplary relationships between active pixel blocks according to an aspect of the present disclosure.

FIG. 13 illustrates an exemplary application of prediction restriction according to an aspect of the present disclosure.

FIG. 14 illustrates another exemplary application of prediction restriction according to an aspect of the present disclosure.

FIG. 15 illustrates exemplary application of reference picture management according to an aspect of the present disclosure.

FIG. 16 illustrates exemplary application of reference picture management according to an aspect of the present disclosure.

FIG. 17 illustrates a method according to an embodiment of the present disclosure.

FIG. 18 illustrates another method according to an embodiment of the present disclosure.

FIG. 19 illustrates exemplary use of a minimum updating size according to an embodiment of the present disclosure.

FIG. 20 illustrates a method for processing frame level syntax according to an embodiment of the present disclosure.

FIG. 21 illustrates a method for processing pixel block level syntax according to an embodiment of the present disclosure.

FIG. 22 is a functional block diagram of an encoder according to an aspect of the present disclosure.

FIG. 23 is a functional block diagram of a decoder according to an aspect of the present disclosure.

FIG. 24 illustrates operations of a BRU replacement operation according to an aspect of the present disclosure.

FIG. 25 illustrates an aspect of the present disclosure involving coded extended blocks.

FIG. 26 schematically illustrates BRU replacement operations involving coded extended blocks according to an aspect of the present disclosure.

FIG. 27 illustrates scheduling of reference picture buffer reads and writes according to an aspect of the present disclosure.

FIG. 28 illustrates another aspect of the present disclosure involving coded extended blocks.

FIG. 29 illustrates BRU operations involving segmentation according to an aspect of the present disclosure.

FIG. 30 illustrates anchor frame processing according to an aspect of the present disclosure.

FIG. 31 illustrates frame composition principles according to an aspect of the present disclosure.

FIG. 32 illustrates another application of filtering according to an embodiment of the present disclosure.

### DETAILED DESCRIPTION

Embodiments of the present disclosure provide techniques for coding video in applications where regions of video are inactive on a frame to frame basis. According to the techniques, coding processes update only a subset of pixel blocks of pixels within a frame, while other pixel blocks are retained from a previously coded frame stored in a coder's or decoder's reference frame buffer. The technique is called Backward Reference Updating (or “BRU”) for convenience. At a desired pixel block granularity, based on the activity between a current frame to be coded and its reference frame(s), BRU may perform prediction, transform, quantization, and reconstruction only on selected region(s) that are determined to be active. The reconstructed pixels in these active regions are directly placed onto a specified reference frame in memory instead of creating a new frame in memory. Therefore, fewer memory transfers are performed. BRU can be used as a universal technique that can be used in future image sequence or video coding specifications and their implementations such as extensions of HEVC (H.265) and VVC (H.266) from MPEG/ITU-T, or of AV1, AV2 and the AVM (AOM Video Model) by the Alliance for Open Media (AOM). The proposed techniques provide benefits in low latency, low memory bandwidth, and low power consumption applications.

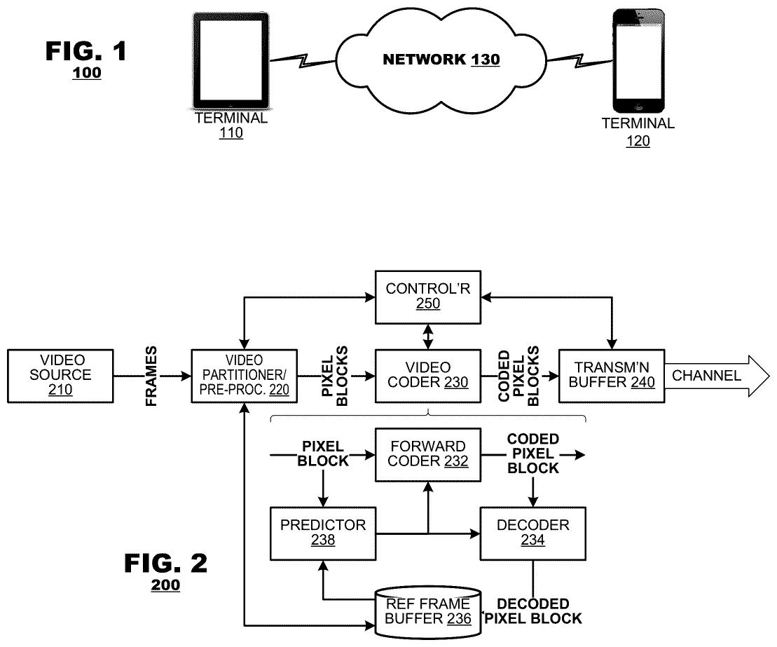

FIG. 1 illustrates a video exchange system 100 according to an aspect of the present disclosure. The system 100 may include two or more terminals 110, 120 that may exchange video data across a communication network 130. Video data generated at a first terminal 110 may be compressed according to video coding processes which reduce the video's bandwidth and may be transmitted to other terminal 120 for decoding and consumption. In the simplified diagram illustrated in FIG. 1, a first terminal 110 may send the video to a second terminal 120. In other applications, however, the first terminal 110 may send the video to multiple terminals (not shown) for consumption in parallel. Moreover, other applications may involve multidirectional exchange of video where, for example, the second terminal 120 may generate its own video data, compress it, and send it to the first terminal 110 for consumption. The principles of the present discussion find application in all such use cases.

In the example of FIG. 1, the terminals 110, 120 are illustrated as tablet computers and smartphones, respectively. The principles of the present disclosure may find applications for a diverse array of terminal devices, including for example, computer services, personal computers, desktop computer, laptop computers, personal media devices, set top devices, and media players. The type of terminal device is immaterial to the present discussion unless noted otherwise herein.

Moreover, the principles of the present disclosure may find applications with a wide variety of networks 130. Such networks 130 may include packet-switched and circuit-switched networks, wired and wireless networks, and computer and communications networks. The architecture and topology of the network 130 is immaterial to the present discussion unless noted otherwise herein.

FIG. 2 is a functional block diagram of an encoding system 200 according to an aspect of the present disclosure. The encoding system 200 may be part of a terminal in FIG. 1 and may carry out the coding of video data for transmission to another terminal, such as the terminal 120 (FIG. 1). The encoding system 200 may include a video source 210, a video partitioner 220, a video coder 230, a transmission buffer 240, and a controller 250. The video source 210 may generate video data that is to be coded and transmitted to other terminal(s) (FIG. 1). The video partitioner 220 may partition frames into sub-regions, called “pixel blocks” for convenience, for coding by the video coder 230. The video coder 230 may apply video compression operations on the video data of the pixel blocks which achieve bandwidth compression. The compression operations may be defined in a video coding specification, for example, in one of HEVC, VVC, AV1, or AV2. The transmission buffer 240 may format the coded pixel block data according to a syntax of a governing coding protocol and prepare it for transmission in a communication channel. Channel data generated by the transmission buffer may be transmitted from the terminal 200 to another terminal device 120 (FIG. 1).

The video coder 230 may be a predictive video coder, which achieves bandwidth compression by exploiting temporal and/or spatial redundancy in video from the video source 210. The video coder 230 may include a forward coder 232, a decoder 234, a reference frame buffer 236, and a predictor 238. The forward coder 232 may code input data of the pixel blocks differentially with respect to prediction data supplied by the predictor 238. The coded pixel block data of the may be output from the video coder 230 and input also to the decoder 234.

The decoder 234 may generate decoded video from the coded pixel block data of frames that are designated reference frames. These reference frames may serve as candidates for prediction of pixel blocks from other frames that are processed later by the video coder 230. The decoder 234 may decode the coded pixel blocks by inverting coding operations that were applied by the forward coder 232. Coding operations of the forward coder 232 typically incur coding losses so the decoded video obtained by the decoder 234 often will resemble the image data input to the forward coder 232 but it will exhibit some loss of information. When a reference frame is completely decoded, the frame data may be stored in the reference frame buffer 236.

The predictor 238 may perform prediction searches between newly received pixel block data and reference frame data stored in the reference frame buffer 236. When the predictor 238 identifies a match, the predictor 238 may supply pixel block data from a matching frame to the forward coder 232 and the decoder 234 for use in predictive coding and decoding.

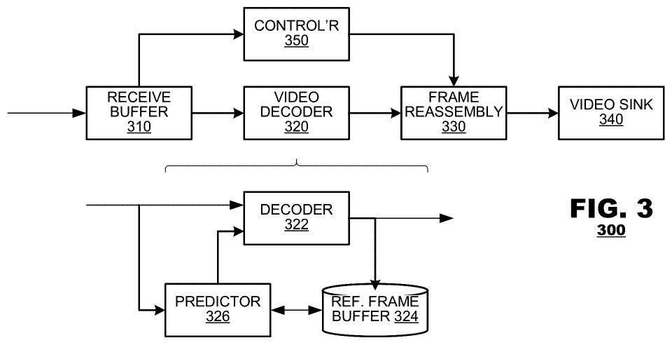

FIG. 3 is a simplified functional block diagram of a decoding terminal (FIG. 1) according to an aspect of the present disclosure. The decoding terminal may include a receive buffer 310, a video decoder 320, a frame reassembler 330, a video sink 340, and a controller 350. The receive buffer 310 may receive coded data representing the video and may deliver the coded data to the video decoder 320. Typically, coded data includes data representing other components of coded multimedia (for example, coded audio), and the receive buffer 310 may forward other data to other units (not shown) assigned to process such data. The receive buffer 310 also may provide pixel block metadata generated by an encoding terminal to the controller 350.

The video decoder 320 may invert coding processes applied by a coder (FIG. 2) to generate recovered pixel block data therefrom. The frame reassembler 330 may generate frame data from the decoded pixel blocks, and may output the frame data to the video sink 340. The video sink 340 may consume the decoded frame data. Typical video sinks 340 include displays to render decoded frame(s), storage devices to store the decoded frames for later use, and computer applications that consume the video.

FIG. 3 illustrates operation of a video decoder 320 in an aspect. The video decoder 320 may include a decoder 322, a reference frame buffer 324, and a predictor 326. The predictor 326 may supply prediction data to the decoder 322 as specified by the coded video data. The decoder 322 may invert the differential coding processes applied by an encoder during coding. The decoder 322 may output the decoded pixel block data. Decoded frame designated as prediction references for later coding operations may be stored in the reference frame buffer 324.

The frame assembler 330 may reassemble a composite frame from pixel blocks output by the video decoder 320. The frame assembler 330 may arrange frame data according to location information contained in coded metadata.

Many coding applications involve video content where a small number of pixels changes from frame to frame. Consider a screen sharing application where computer generated content contains user interface elements that are static across multiple frames of video, while other content (for example, a cursor or application content in a sub-window of the frame) changes. In such coding applications, many pixel blocks will contain content that does not change between successive frames; such pixel blocks are deemed to be “inactive” pixel blocks for purposes of the present discussion. Other pixel blocks, those that contain content that changes between frames, may be considered to be “active” pixel blocks. In an encoding system 200 (FIG. 2), a preprocessor 220 may classify pixel blocks as either active or inactive as compared to a source version of a reference frame stored in a reference frame buffer 236 of the encoder 230. The controller 250 may configure operation of the video coder 230 based on a determination that a pixel block being coded by the video coder 230 is either active or inactive. The encoding system 200 may provide, in coded video data, identifiers that indicate which pixel blocks were determined to be active and which were determined to be inactive. A controller 350 in a decoding system 300 (FIG. 3) may configure operation of the video decoder 320 in response to those identifiers.

As discussed, it is common to employ coding protocols that are defined by video coding specifications to encourage interoperability between encoders and decoders from different vendors. The techniques proposed herein may be cooperatively with these video coding standards by defining a protocol to indicate active and inactive regions. First, the techniques may be employed at coding granularities defined by the coding specifications, at, for example, the largest coding unit level, a coding level unit level, a super block level, or a macroblock level, depending on the specification that is employed; these coding granularities represent pixel blocks as discussed herein. Moreover, syntax elements may be added to the video coding specification(s) to identify the pixel blocks that are classified as active and those identified as inactive.

Backward reference updating can promote conservation of processing resource in applications, such as screen sharing and video conferencing, where frame active region(s) are relatively small in comparison to inactive regions such that relatively few pixels need to be coded and/or copied in each frame, and, particularly, when spatial and temporal motion in the frame content are continuously smooth. In such applications, the data to overwrite prior content from reference frames should be sparse, i.e., the area of active region is smaller than the inactive region. As a result, a video coding system can save bandwidth and power on frame processing because the majority of the frame's spatial area will be inactive.

When BRU is performed on a reference frame, some portion of data already stored in the reference frame is overwritten. This is equivalent to evicting a reference frame in the reference frame buffer 236, 324, though no memory operations are performed to ‘drop’ the frame. Video encoders and decoders 230, 320, however, perform synchronous operations to maintain pools of reference frames that are available for use a reference frames when coding new input frame; when an overwrite operation is performed on a previously decoded reference frame, the previously decoded reference frame should be disqualified from serving thereafter as a prediction reference during later coding because it will no longer be intact in the buffer pool. A new reference frame effectively is created when content of active pixel blocks overwrites co-located content of the previously decoded reference frame; the new reference frame may be added to the buffer pool for use thereafter in coding new input frames. Moreover, processes should be employed to display the ‘dropped’ reference frame before it is overwritten.

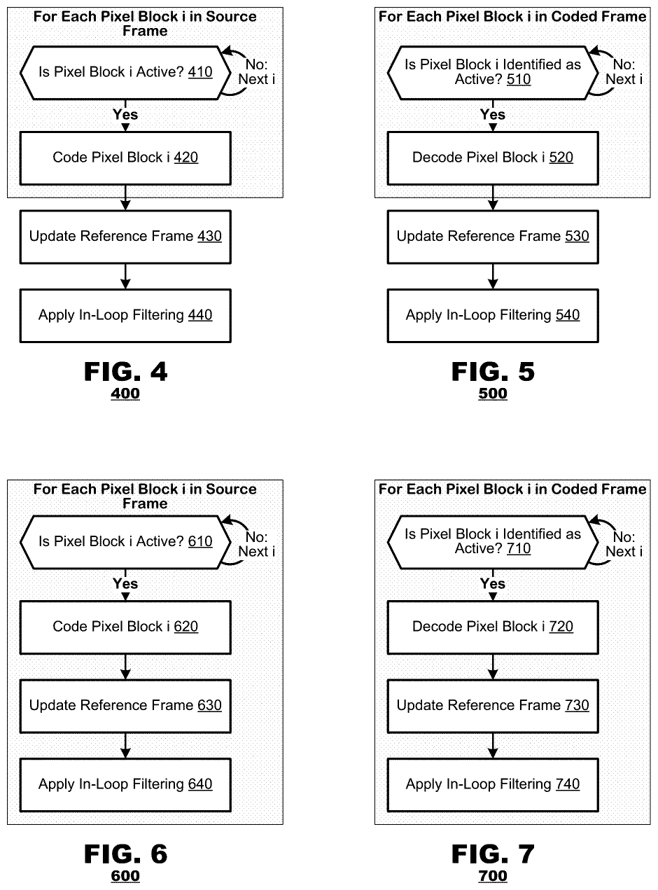

FIG. 4 illustrates a video coding method 400 according to an embodiment of the present disclosure. The method 400 may determine, for each pixel block from a source frame to be coded, whether the source frame is active or not (box 410). The determination may be made, for example, from examination of the video data by a preprocessor or from identifiers of changes in video data provided by a source of the video data. If the pixel block is determined to be inactive, coding of the pixel block may be skipped. If the pixel block is determined to be active, the method may cause the pixel block to be coded (box 420). The operations of boxes 410 and 420 may be performed for all pixel blocks of the source frame.

After coding of the frame's active pixel blocks completes, the method 400 may decode the coded pixel block(s) and cause corresponding portion(s) of a previously stored reference frame in the reference frame buffer 236 (FIG. 2) to be updated (box 430). The method 400 also may perform in loop filtering on the updated reference frame (box 440). Operations of boxes 430 and 440 may cause content of the reference frame to be overwritten in the encoder's reference frame buffer.

FIG. 5 illustrates a video decoding method 500 according to an embodiment of the present disclosure. The method 500 may determine, for each pixel block from a coded frame, whether the source frame is active or not (box 510). The determination may be made, for example, from identifiers provided in coded video data that identifies pixel blocks either as active or inactive. If the pixel block is determined to be inactive, decoding of the pixel block may be skipped. If the pixel block is determined to be active, the method may cause the pixel block to be decoded (box 520). The operations of boxes 510 and 520 may be performed for all pixel blocks of the source frame.

After decoding of the frame's active pixel blocks completes, the method 500 may cause a previously stored reference frame in the reference frame buffer 324 (FIG. 3) to be updated (box 530). The method 500 also may perform in loop filtering on the updated reference frame (box 540). Operations of boxes 530 and 540 may cause content of the reference frame to be overwritten in the decoder's reference frame buffer 324.

FIG. 6 illustrates a video coding method 600 according to an embodiment of the present disclosure. The method 600 may determine, for each pixel block from a source frame to be coded, whether the source frame is active or not (box 610). The determination may be made, for example, from examination of the video data by a preprocessor or from identifiers of changes in video data provided by a source of the video data. If the pixel block is determined to be inactive, coding of the pixel block may be skipped. If the pixel block is determined to be active, the method may cause the pixel block to be coded (box 620). Once the pixel block is coded, the method 600 may cause the coded pixel block to be decoded and a previously stored reference frame in the reference frame buffer 236 to be updated with the decoded pixel block (box 630). The method 600 also may perform in loop filtering on the updated reference frame (box 640). Operations of boxes 610-640 may be performed on each pixel block of the source frame in sequence.

FIG. 7 illustrates a video decoding method 700 according to an embodiment of the present disclosure. The method 700 may determine, for each pixel block from a coded frame, whether the source frame is active or not (box 710). The determination may be made, for example, from identifiers provided in coded video data that identifies pixel blocks either as active or inactive. If the pixel block is determined to be inactive, decoding of the pixel block may be skipped. If the pixel block is determined to be active, the method may cause the pixel block to be decoded (box 720). Following decoding of the pixel block, the method 700 may cause a previously stored reference frame in the reference frame buffer 324 (FIG. 3) to be updated (box 730). The method 700 also may perform in loop filtering on the updated reference frame (box 740). Operations of boxes 710-740 may be performed on each pixel block of the coded frame in sequence.

The methods of FIGS. 4-7 may reduce memory bandwidth and complexity requirements of predecessor skip coding techniques by copying decoded active pixel blocks back to previously stored reference frames of a reference frame buffer 236 (FIG. 2) or 324 (FIG. 3). In FIG. 2, the decoded pixel blocks may be generated by decoder 234. In FIG. 3, the decoded pixel blocks may be generated by decoder 322. This technique avoids memory reads and writes that otherwise would be incurred by copying inactive blocks from a stored reference frame then storing a new reference frame to memory that is composed of the active pixel blocks from the new frame and the inactive pixel blocks from a stored reference frames. At the decoder, this operation may be restricted to the reference frames that already have been displayed to avoid corruption in a device's display buffer.

The methods of FIGS. 4 and 5, will copy all the reconstructed pixels of the active coding blocks at the same time to the reference frame buffer 236 (FIG. 2) or 324 (FIG. 3) before in-loop filtering. In this case, separate reconstruction frame buffers may be maintained in the encoder 230 and the decoder 320 because, at each decoded active coding block, the reconstructed pixels need to be saved before copying them to the corresponding reference frame. The methods of FIGS. 6 and 7 do not involve frame buffers. Instead, a buffer as large as a pixel block is enough, which is beneficial for a hardware pipeline design. The methods of FIGS. 6 and 7 will update the corresponding reference frame with a unit of a pixel block right after the current pixel block is decoded and reconstructed, as in FIGS. 6 and 7.

Identification of active and inactive regions may be performed in a variety of ways. In one embodiment, an encoder may signal a bit map that identifies active and inactive pixel blocks before providing coded content of the frame. In another embodiment, coded pixel blocks may content a flag that identifies whether the frame is active or inactive.

For example, at the beginning of each frame/tile, a bru_enabled flag may be signaled to indicate whether the frame/tile has the BRU scheme enabled. In an AV2 application, a BRU frame may be identified in an Open Bitstream Unit element (OBU) before providing coded payload of the frame. In such an application, a decoder may prepare frame buffers before doing actual decoding of the BRU enabled frame. If the decoder receives a bru_enabled=0, the decoder may perform normal prediction and reconstruction processes for the entire coded frame/tile. A bru_enabled=1 may indicate that BRU processes have been applied to the frame. Thus, right after a coding block is received with the block segmentation information, the decoder will be able to fully determine the status of the current coding block. If the pixel block is designated as an inactive block, the pixel block may contain no coded payload, and the decoder need not perform any decoding operation. Otherwise, if the pixel block is an active block, the decoder may perform prediction and reconstruction processes as defined in the coded pixel block payload. The decoded information of the active region(s) will be copied to the corresponding reference frame in the reference frame buffer 324.

As discussed, when a coding block is determined to be inactive, decode processes will not be applied at an encoder 230 or a decoder 320 and the reconstruction buffer pixel values of the inactive region are undefined. Moreover, in a pipelined hardware implementation, it may occur that, at the time an encoder or decoder processes a given pixel block, information of other previously coded active pixel blocks may not be available because, for example, they have not been committed to memory (the reference frame buffers 236 or 324). In such cases, the encoder 230 or decoder 320 has certain regions of a frame available to it and other regions of the frame unavailable to it.

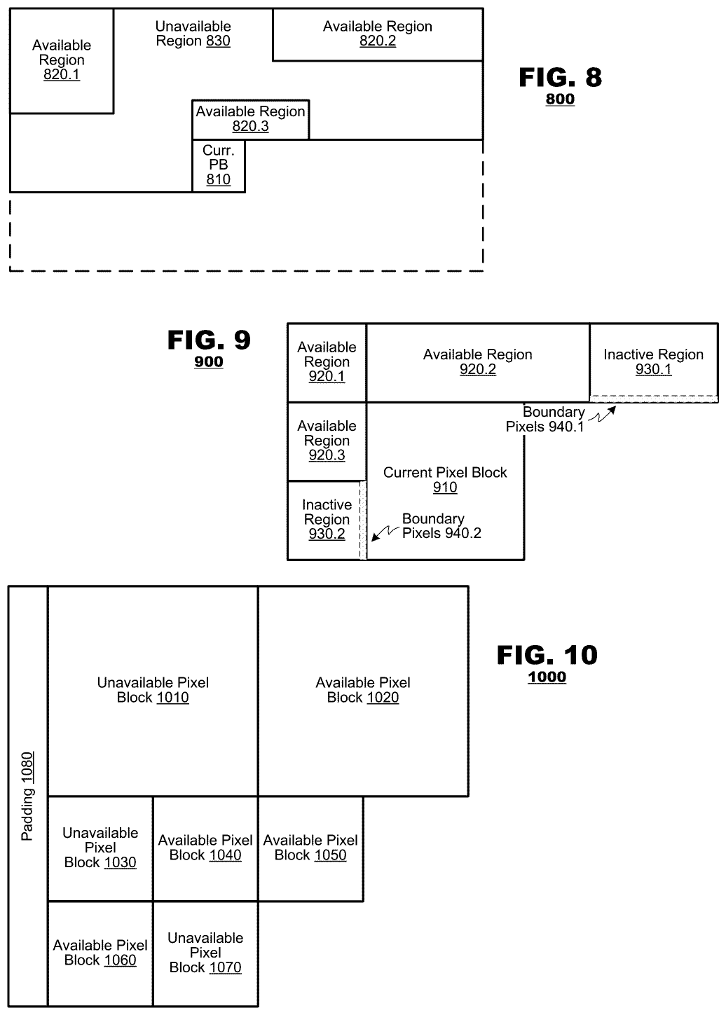

FIG. 8 illustrates an exemplary frame 800 that illustrates the phenomenon of available and unavailable regions. The example illustrates coding state of the frame 800 at a time when an encoder processes a current pixel block 810 from the frame 800. Video coders typically process pixel blocks in a predetermined coding order; in the example of FIG. 8, the pixel blocks are shown coded in a raster scan order that progresses from a top, left-most position in the frame 800 leftward across a first row, then repeats left to right across successive rows.

At the time the current pixel block 810 is being processed, previous locations of the frame 800 in the raster scan order may have been considered for coding but content for those locations may not be available to an encoder or a decoder. Some reconstructed regions of the frame 820.1, 820.2, 820.3 may be available to the encoder and decoder. Other locations, shown as 830, may be unavailable because, for example, pixel blocks of those locations were designated an inactive by one of the methods of FIGS. 4-7 or because they were processed as active regions but have not been committed to memory at the time the current pixel block is processed 910.

When BRU processing is performed on a frame, many coding tools that rely on pixels in a current reconstruction buffer can be affected. Take intra prediction as an example, when a coding block is adjacent to any inactive coding blocks, the intra prediction may not have valid boundary pixels as in the non-BRU case. As illustrated in FIG. 9, at the time a current pixel block 910 is coded, some other pixel blocks may have been classified as inactive, as described previously; the pixels in the inactive regions 930.1, 930.2 may be undefined. An encoder 230 and/or decoder 320 may either set the boundary pixels 940.1, 940.2 to a deterministic value, or mark them as unavailable to disallow the use of those boundary pixels for intra prediction. One alternative solution is to inherit the inactive pixels from the BRU reference frame such that all the ‘undefined’ or ‘unavailable’ restrictions can be relaxed. Moreover, side information such as motion vectors and activity map of such inactive regions could also be inherited.

As an alternative approach, encoder 230 and/or decoder 320 may infer pixels in unavailable regions from other pixels of available regions 920.1, 920.2, 920.3 surrounding the unavailable pixels if possible, using techniques such as extending or interpolating. A similar condition could also apply when an encoder evaluates Intra Block Copy (IBC) techniques for the current pixel block 910. If the region to be copied contains any inactive regions 920.1, 920.2, or 920.3, the encoder 230 may set them to a deterministic value or just do not use those regions. A decoder 320 may follow these same techniques.

An alternative approach may be more implementational friendly, i.e., the decoder implies that ibc_allowed=0 for any frame with bru_enabled=1.

BRU techniques may alter application of in-loop filters in an embodiment. Most importantly, filters need not be applied on the reconstructed frame buffer, but directly on the corresponding updated reference frame. In general, in-loop filters may be applied to border pixels between adjacent available coding blocks or between available and unavailable coding blocks. In the example of FIG. 10, filtering may be applied at borders between adjacent available pixel blocks 1020 and 1050 and between available pixel blocks 1040 and 1050. Filtering also may be applied at boundaries between an available pixel block 1020 and an unavailable pixel block 1010, between available pixel block 1040 and unavailable pixel block 1030, between available pixel block 1060 and unavailable pixel block 1030, between available pixel block 1040 and unavailable pixel block 1070, and between available pixel block 1060 and unavailable pixel block 1070. Filtering would not be performed between two adjacent unavailable pixel blocks, such along the boundary between pixel blocks 1010 and 1030.

In some coding applications where pixel blocks along an edge of a frame are coded, it can be common for video coders and decoders to develop padding content 1080 along the edge boundaries of pixel blocks for filtering purposes. In another example, filtering may be applied also on boundaries between available pixel blocks such as block 1030 and the padding content 1080. Filtering would not be performed at boundaries between unavailable pixel blocks 1010, 1060 and the padding region.

As discussed (FIGS. 4-7), filters may be applied at different stages in different embodiments of the disclosure. In all embodiments, processing resources are conserved when filtering is performed only in locations where active pixel blocks have been decoded and they have updated the reference frame. As shown in FIGS. 4 and 5, the filtering processes (boxes 440, 540) are triggered after the entire reference frame has been updated. In FIGS. 6 and 7, however, filtering (boxes 640, 740) can be performed as long as all the pixels in the filtering region (inactive or active) are available by a processing pipeline (not shown) of the encoder or decoder in which the methods operate. In either scheme, operation of in loop filters may be synchronized between encoders and decoders to ensure a common set of source data is available to the encoders and decoders.

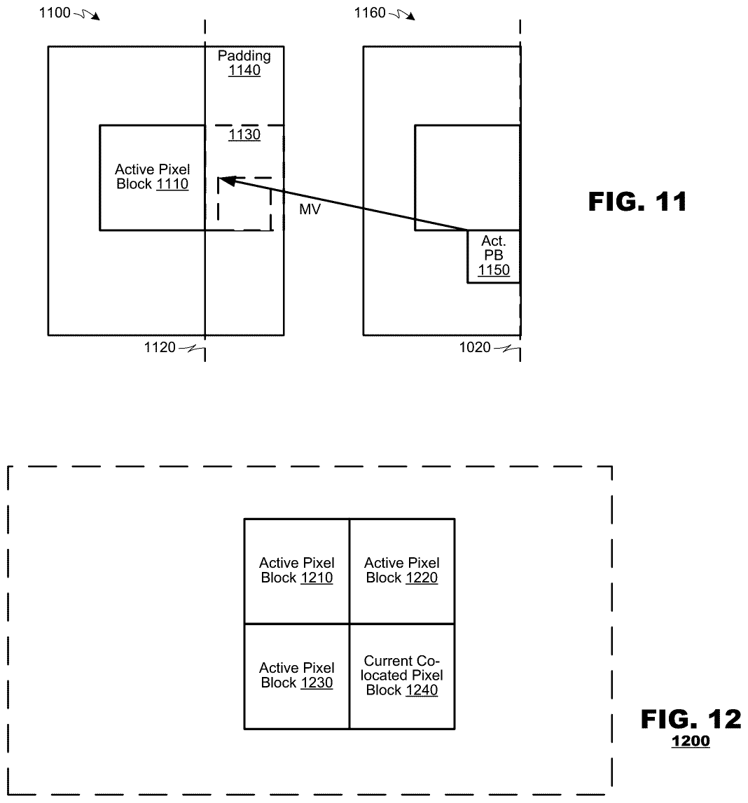

Many typical inter prediction tools, as well as the filtering processes, use padded pixels for better performance and universal implementation. One example is shown in FIG. 11. In this example, a first frame 1100 has one active decoded pixel block 1110 at the frame's boundary 1120. In this example, assume that all the other pixels in the frame, decoded before the pixel block 1110, are inactive. The BRU coding processes may copy pixel block 1110 and update a portion 1130 of the adjacent padding region 1140 in the corresponding reference frame. This allows the padded region 1130 to be used by coding block(s) 1150 of future frames 1160 as a prediction reference for inter prediction. If the padded region 1130 is not updated synchronously by an encoder 230 and decoder 320 after the active coding block 1110 is copied, the encoding and decoding processes will have different pixel values in the reference buffer.

Filters on frame boundar(ies) may be managed by the BRU process. As shown in FIG. 11, if border pixels in the corresponding reference frame 1100 (which will also be used as the current reconstructed frame) are not padded correctly before filtering, i.e., there are active coding blocks on the border but the padded pixels are still kept the same as in the previous frame, the filtered boundary pixels will be inconsistent. The encoder 230 and decoder 320 may perform padding at synchronous in the FIGS. 3 and 4 embodiments before filtering (steps 440, 540). The encoder 230 and decoder 320 may perform on-the-fly padding for each pixel block on the frame boundary that contains active coding blocks in the FIGS. 5 and 6 embodiments.

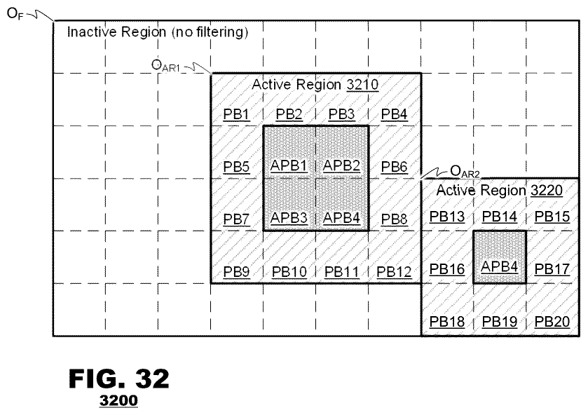

FIG. 32 illustrates another application of filtering according to an embodiment of the present disclosure. In the illustrated embodiment, a frame 3200 is shown with two active regions 3210, 3220. The first active region 3210 is comprised of active pixel blocks APB1-APB4, and the second active region 3220 is comprised of another active pixel block APB5. The active regions 3210, 3220 each may include other inactive pixel blocks PB-1-PB12 and PB13-PB20 that surround the active pixel blocks APB1-APB4, APB5 of the respective regions 3210, 3220.

In an embodiment, communication of filtering operations between an encoder and a decoder (FIG. 1), for example, operations to be performed by an in-loop filter (discussed hereinbelow), may be tailored according to the active region(s) that are defined within video frames 3200. First, filtering operations may be defined with respect to origin locations O_{AR1}, O_{AR2} of the active regions 3210, 3220 rather than an origin O_{F} of the frame 3220. Typically, the origin locations O_{AR1}, O_{AR2} of the active regions 3210, 3220 will be a first pixel location of each region as determined by a predetermined scan pattern, such as a raster scan pattern. Additionally, encoders may signal operational filter parameters to be used according to the size(s) and shape(s) of the active regions 3210, 3220. For example filter parameter coefficients may be selected so that inputs to the filtering operations are confined to pixel locations within the active regions 3210, 3220. In other words, filter parameters may be selected so that pixels contained within inactive region(s) of a frame 3200 do not become inputs to the filter operations. Coefficients that correspond to pixel locations in inactive region(s), for example, may be set to zero. In this manner, decoders may perform filtering operations for the active pixel blocks APB1-APB4, APB5 in the active regions 3210, 3220 without necessitating accesses to system memory to retrieve pixel values from inactive region(s).

In some embodiments, the encoder 230 and decoder 320 perform pipelined implementations for the BRU updates, especially in the FIGS. 6 and 7 embodiments. The pipeline may impose delay upon neighboring blocks that are active. FIG. 12 demonstrates one example at a decoder. Assume that, in the current frame 1200, there are only 4 active pixel blocks 1210-1240. After decoding super blocks 1210 and 1220, the decoder will copy the active pixels back to the BRU reference frame at corresponding locations 1210, 1220. The decoder will then directly process pixel blocks 1230 and 1240. At the time of decoding pixel block 1240, which might require information from neighboring active regions 1210-1230, the BRU process in such neighboring regions 1210-1230 may not have completed. In this case, the encoder should apply restriction criteria to avoid some restricted regions 1210-1230 in the corresponding reference frame for inter prediction.

The restriction criteria could be different in different decoder designs. In one embodiment, an encoder may signal a group of restricted region offsets at a sequence level in a coding syntax, which causes motion vector coding for all inter coding blocks to be modified based on the offsets to also reduce bitrate. The pixels in the current collocated pixel block in the reference frame that will be overwritten are always available.

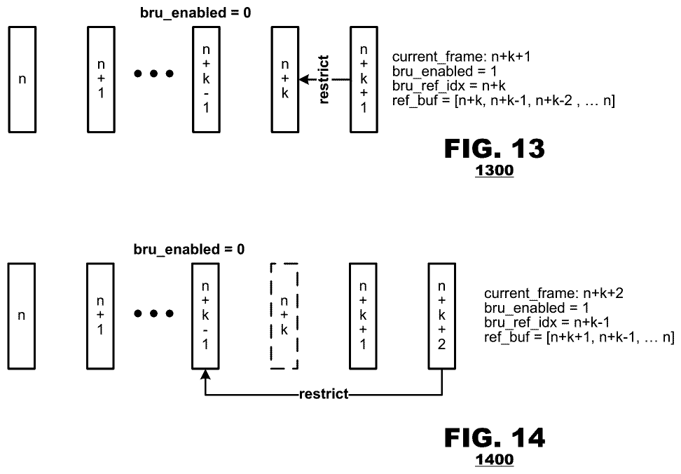

One restriction criteria, which may decrease the complexity introduced by motion vector restriction in the case of FIGS. 6 and 7, may prohibit active pixel blocks from using inter-prediction that relies on pixels in the BRU reference frame 1200. A decoder may maintain a valid reference frame list as the regular BRU does, but the BRU reference frame to be overwritten will be in the reference picture pool, as shown in FIG. 13. With BRU employed (bru_enabled=1), there will be N−1 reference frames available for regular inter prediction (where N is the total number of reference frames available).

FIG. 13 illustrates reference frame pool management in an exemplary frame sequence. In this example, a frame n+k+1 is being coded according to BRU techniques. A bru_ref_idx index identifies reference frame n+k as the frame that will be overwritten following BRU processing. At the time frame n+k+1 is coded, a pool of reference frames includes the frames n+k to n as candidate reference frames.

In this example, a prediction restriction may be applied that causes the frame identified by bru_ref_idx (frame n+k in the example of FIG. 13) to be disqualified from serving as a prediction reference for frame n+k+1 even though it otherwise would be available to serve as a prediction reference. The prediction restriction may prevent data conflicts that might occur in pipelined processing systems if data were unavailable when a pipeline processing stage required it. For example, if one stage of a processing pipeline were decoding a portion of a reference frame (say a first active pixel block) that is needed as a prediction reference in a process performed by a second stage of the pipeline (for a second active pixel block of the same frame), the second stage could not complete its task until data from the first stage became available. A prediction restriction may avoid such data dependencies among pipeline processing stages in this scenario.

FIG. 14 illustrates reference pool management that may occur following processing of the frames illustrated in FIG. 13. In this example, a frame n+k+2 is being coded, again, according to BRU techniques. A bru_ref_idx index identifies reference frame n+k+1 as the frame that will be overwritten following BRU processing. At the time frame n+k+1 is coded, a pool of reference frames includes the frames n+k+1, and n+k−1 to n as candidate reference frames. Note that reference frame n+k from FIG. 3 does not exist in the reference frame pool; as discussed, in BRU processing techniques effectively evict overwritten reference frames (here, frame n+k) from the pool when they are overwritten.

In this example, a prediction restriction may be applied that causes the frame identified by bru_ref_idx (frame n+k−1 in the example of FIG. 14) to be disqualified from serving as a prediction reference for frame n+k+2 even though it otherwise would be available to serve as a prediction reference. Again, the prediction restriction may prevent data conflicts that might occur in pipelined processing systems if data were unavailable when a pipeline processing stage required it. The prediction restriction may avoid data dependencies that might arise when active pixel blocks of frame n+k+2 are decoded and overwrite blocks of frame n+k−1.

In coding applications that favor use of the BRU techniques, updating may occur continuously from frame to frame without interruption. Assume that BRU techniques are used in every frame. In this case, encoders 230 and decoders 320 will develop only one reference frame in their reference frame buffers 236, 324. Overall coding quality may be harmed due to a lack of variety of reference frames. In an embodiment, an encoder 230 could intentionally turn off BRU processing for some frames that otherwise would be coded efficiently using those techniques. For example, the encoder could turn off BRU for N frames when it is determined that the number of reference frames in the reference frame pool falls below a threshold number.

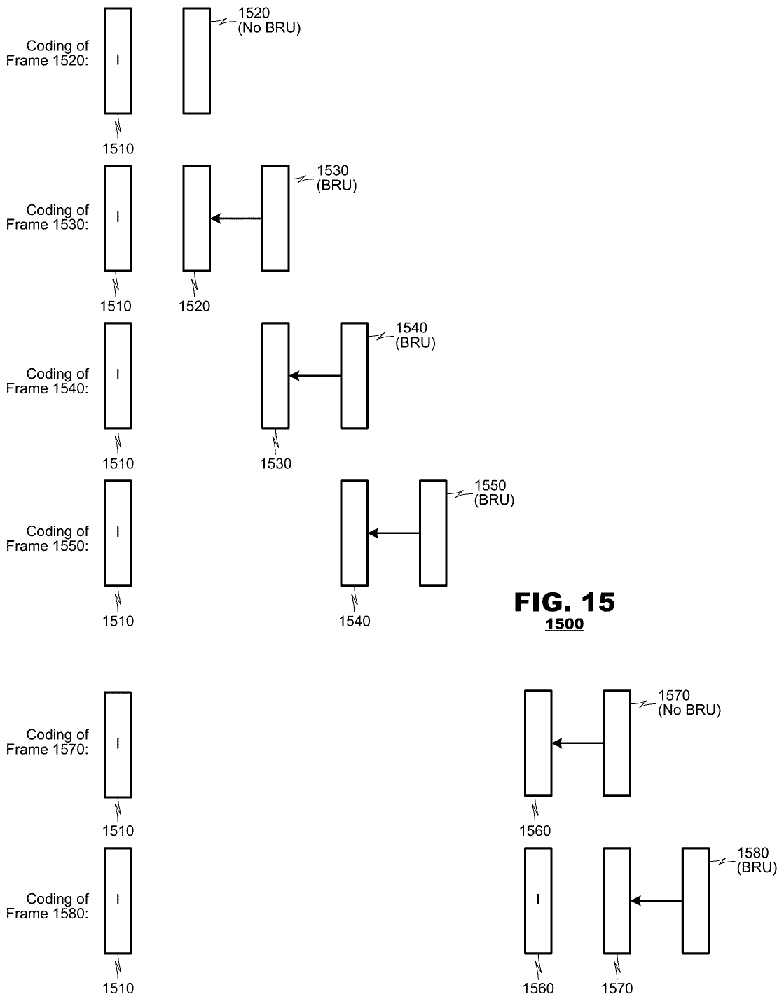

In one implementation, an encoder may disable BRU techniques on a predetermined basis. One such example is illustrated in FIG. 15, where different frames are selected for coding at different coding qualities. In this example, a frame 1510 at a first temporal layer is selected for coding at high quality. When coding is performed on a second frame 1520, BRU techniques may be disabled for the second frame 1520 which prevents the second frame 1520 from overwriting the high quality frame 1510 in a reference frame buffer. Thereafter, BRU techniques may be enabled for other frames 1530, 1540. For example, when frame 1530 is coded using BRU techniques, it may cause an overwrite of certain data in reference frame 1520 in the reference frame buffer. Reference frame 1520 thereafter would be removed from the pool of available reference frames, as when frame 1540 is coded. Frame 1540 would have frames 1510 and 1530 available as prediction references. Moreover, if frame 1540 is coded using BRU techniques involving an overwrite of content in reference frame 1530, reference frame 1530 may be removed from the pool of reference frames, leaving frames 1510 and 1540 available for coding later received frames, such as when frame 1550 is coded. In this example, frames 1530-1550 each are coded by BRU techniques, each of which overwrites its immediate predecessor frame. But, since BRU techniques were disabled when coding frame 1520, the high quality frame 1510 remains available as a source of prediction for the frames 1530-1550 as they are coded.

At some point, another frame 1560 may be selected for high quality coding. In this event, the process of disabling BRU coding of select frames may be repeated. As illustrated, BRU coding may be disabled for frame 1570, which prevents content of frame 1560 from being overwritten in a reference frame buffer. But the BRU techniques may be reengaged for subsequent frames, such as frame 1580, which may cause an overwrite to frame 1570 in the encoders and decoders' reference frame buffers.

Selection of frames to preserve may be done in a variety of ways. Many video coders organize frames into Group of Frame (GOP) constructs in which the first coded frame of each GOP is coded with the highest possible quality as compared to other frames of the GOP. Other protocols employ intra refresh coding techniques in which intra coded frames are assigned relatively high coding quality. Other rate control techniques may assign to select frames high coding qualities. In each case, the frames that are coded with high coding quality may be selected for preservation by disabling BRU coding techniques for other frames that otherwise would overwrite content of the high quality coded frame.

As a corollary, when the coding quality of different frames varies, such as the frames in a GOP with different temporal layers, or when Rate Control is enabled, BRU coding techniques may be applied to select a reference frame to be overwritten that has a similar coding quality frame as the reference frame being coded. In this manner, low quality reconstructions will not propagate to high quality reconstructions that will be used in the future coding.

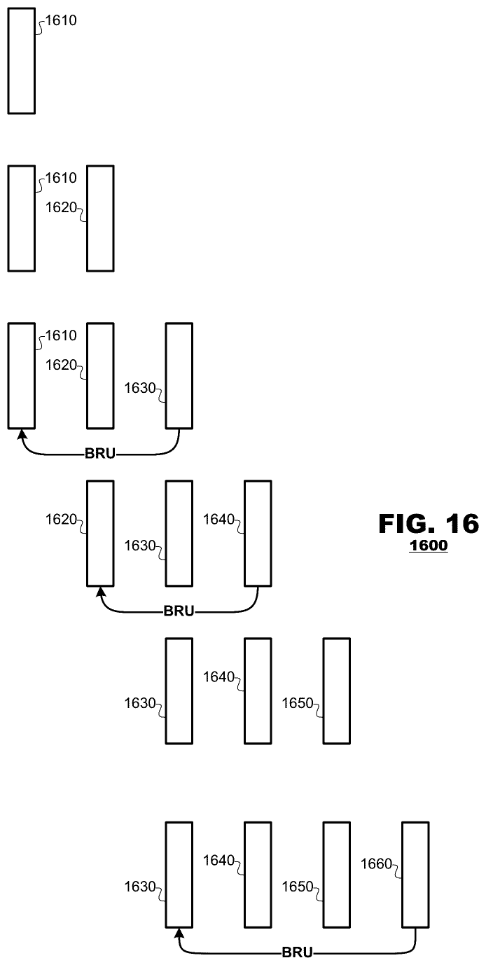

In another embodiment, illustrated in FIG. 16, encoders and decoders may maintain N reference frames in their reference frame buffers and choose the oldest reference frame as the BRU reference frame. This ensures that the current frame always has N references (or N−1 in case the BRU reference frame is not allowed for inter-prediction). An example is shown in FIG. 16.

In the example of FIG. 16, frame 1610 is shown as the first coded reference frame. When Frame 1620 is coded, BRU coding may be disabled, which preserves frame 1610 in the reference frame buffer. This may occur if, for example, the reference picture has not been filled to a desired number of reference frames.

In the example of FIG. 16, frame 1630 may be coded using BRU techniques, with the oldest frame 1610 in the reference frame buffer selected to be overwritten. Overwriting frame 1610 effectively causes it to be evicted from the reference frame buffer in favor of the new coded reference frame 1630. Frame 1640 may be coded using BRU techniques, with the oldest frame 1620 in the reference frame buffer selected to be overwritten.

In the example of FIG. 16, frame 1650 is not coded according to BRU techniques, which causes it to be added to the reference frame buffer with frames 1630 and 1640. When frame 1660 is coded, it may be coded using BRU techniques with the oldest reference frame 1630 being selected to be overwritten.

Signaling of BRU information may occur in a variety of ways. A sequence level seq_bru_enabled flag may be provided to signal in a sequence header OBU if BRU scheme are used in decoding this sequence.

BRU information also may be provided at the frame level. For example, a bru_enabled flag may be provided at the frame level, along with other fields such as a reference index and motion vector restriction information. The BRU syntax elements can be provided in the frame header OBU or by defining a BRU OBU before a frame header syntax element. If the encoder and decoder have a scheme for encoding skipped sub blocks such as Segmentation tools as provided in AV2, BRU can be signaled together with such tools.

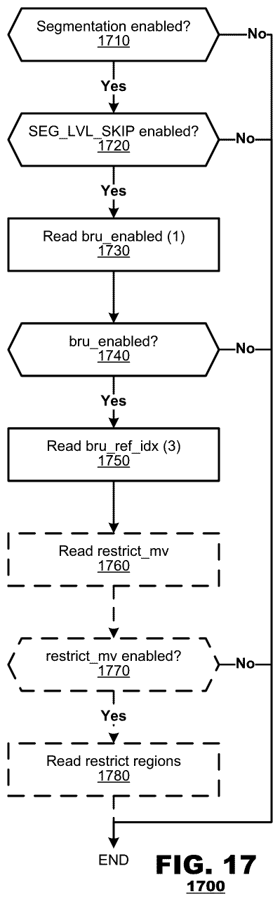

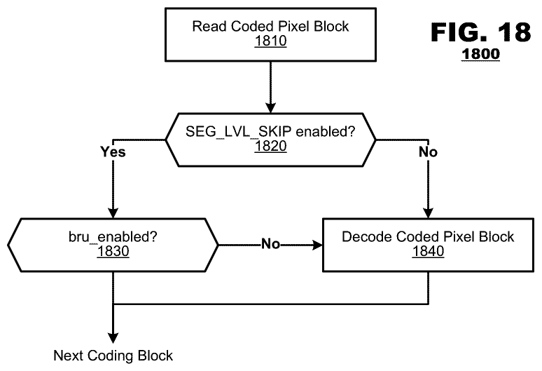

Continuing with the AV2 example, BRU frame level information can be signaled through segmentation frame level information as shown in FIG. 17. If segmentation of the current frame is enabled (step 1710) and the segment skip feature is also enabled (step 1720), the decoder may parse the bru_enabled flag first (step 1730). If bru_enabled=0, no further BRU parsing need be performed and the current frame is not a BRU frame (but still can be a segment skip frame). If bru_enabled=1, bru_ref_idx, which indicates which reference frame is used for updating and restrict_mv, which signals whether or not the motion vectors should be restricted, can also be signaled (step 1740). The region of restriction could be pre-defined or signaled, as mentioned above.

For example, in one embodiment, signaling information may identify a number of restriction areas and their corresponding location offsets and sizes as shown in Table 1. The method 1700 may read a restrict_mv flag to determine whether motion vector restrictions have been applied (boxes 1760, 1770). If so, the method 1700 may read identifiers of restricted regions from coded frame data (box 1780) and apply them as prediction restrictions, effectively disqualifying the identified region(s) from serving as prediction references for the frame. Although providing identifiers of restricted regions is optional, their use can promote resource conservation at a decoder.

TABLE 1
Segment Levels and Features

| Feature Data | Description | Size |
|---|---|---|
| bru_enabled | indicates whether the current frame uses BRU | 1 |
| bru_ref_idx | reference index to be updated by BRU | 3 |
| restrict_mv | indicates whether the motion vector needs to be | 1 |
| (optional) | restricted | |
| restrict_regions | indicates the restrict region rectangles | vary |
| (optional) | | |

In the embodiment of AV2, there is no extra signaling in the sub block level for the BRU. As shown in FIG. 18, when the coding block is segment skip and bru_enabled=1 at the frame level (steps 1820, 1830), the current sub block will not perform prediction and reconstruction. The BRU copy process will be triggered as described in FIGS. 4-7 for all the active sub blocks. The target of updating is the reference frame signaled in the bru_ref_idx syntax element. If the codling block signaling fails either test at steps 1820 or 1830, then the pixel block is active and decoding is performed (step 1840).

In a pipelined hardware system, processing conflicts may arise among different parallel units that perform different processes. For example, the decoding process performed by a first processing unit may access an area in the reference buffer while this area is being updated through BRU by the decoding process of other unit(s). Therefore, it may be useful to restrict the values of the motion vectors to avoid such conflicts. In one example, using references that may cross a slice/tile boundary may be disallowed.

When a slice/tile does not contain any active regions, it would be desirable to skip decoding this parallel unit immediately. Therefore, a flag (parallel_unit_skip_flag) in a parallel unit level may be provided to indicate whether the slice/tile is a skip unit or not. When the flag is 1, the unit is an inactive unit and the decoding process of this slice/tile is skipped. It is noted that there is no further information that is signaled for a skip parallel slice/tile.

When parallel_unit_skip_flag is 0, it may indicate that the unit has active regions. In this case, a segmentation map flag may be signaled for this unit if enable_segment is 1 at the frame level. If the segmentation is enabled for a unit, a segmentation map also may be transmitted to indicate which Segment ID will be used in which spatial regions of the unit. As introduced in FIG. 2 and in Table 1, the segmentation map is a buffer that is stored in the minimum coding block level, i.e. 8×8. The value of the segment map may indicate one of the pre-defined Segment IDs. Each coding block will signal only one segment ID. Different parallel units may share the same segment table, which is signaled at the frame level.

When a parallel unit is not a skip unit, a flag (parallel_unit_bru_enabled) may be signaled to indicate whether BRU is enabled for this unit or not. If parallel_unit_bru_enabled=1, BRU is enabled for this unit and a syntax element (bru_ref_idx) may be added to indicate which reference buffer will be updated by this unit. It is noted that different BRU units in a frame may have different bru_ref_idx values.

In one embodiment, frames may not be output at the earliest time, but delayed by a few frames. If any parallel unit is used as a BRU reference before the frame that it is in is output for display, that parallel unit may be updated after it had been decoded but before being output. This delay may be beneficial in that the update may improve the quality of that parallel unit.

In another embodiment, block bru_skip flags may be signaled in a coding syntax to indicate when BRU processes are disabled. This embodiment avoids use of segmentation (or implementation in the other codecs). In such embodiments, to save the coding bit cost of signaling such flags, a predefined minimum updating size (min_bru_size) may be defined in a coding protocol that defines a pixel block granularity at which flags are provided. Pixel blocks at smaller granularities may be inherited from larger pixel blocks to which they belong.

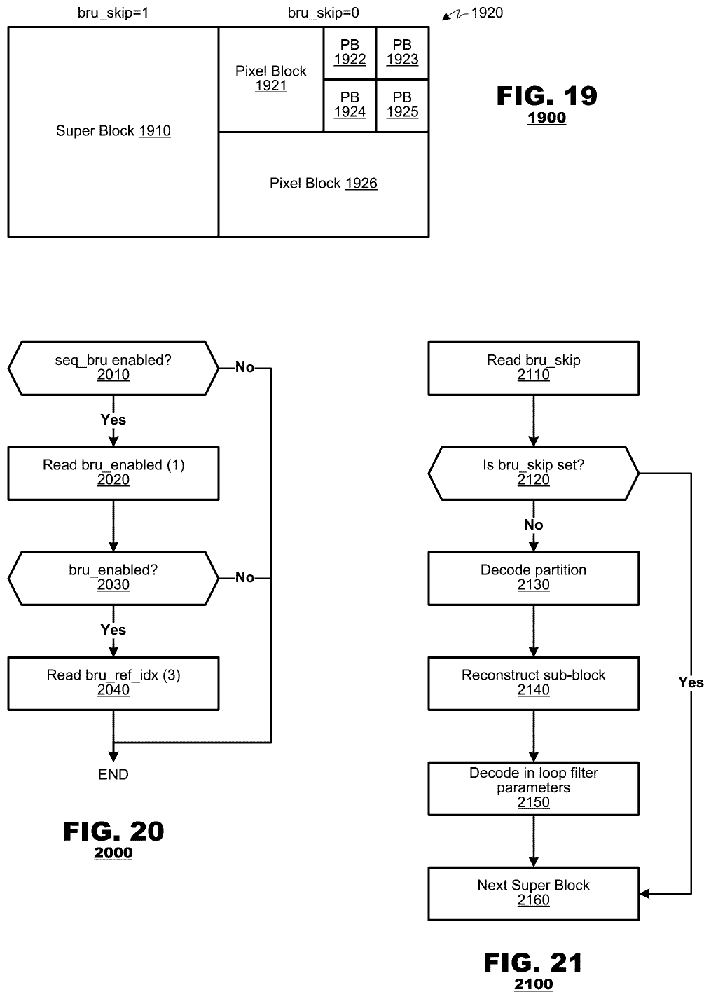

One such example is illustrated in FIG. 19, as applied to an exemplary AV2 coding scenario. In this example, BRU skip flags may be defined at a Super Block level. In this example, if the Super Block bru_skip=1 as is shown for Super Block 1910, the entire Super Block will not perform prediction and reconstruction. But, if the Super Block's bru_skip=0, as is shown for Super Block 1320, all the sub blocks 1921-1926 inside this Super Block will perform regular decoding process without decoding bru_skip again. A sequence level seq_bru_enabled flag may be employed to turn BRU on or off to the entire bit stream.

FIG. 20 illustrates a method 2000 for processing frame level syntax according to an embodiment of the present disclosure. A decoder may read a seq_bru_enabled flag to determine whether BRU processing is enabled (box 2020). If not, BRU processing may be skipped for the frame. If the seq_bru_enabled flag is enabled, then the method 2000 may read the bru_enabled flag for the frame (box 2020) and determine whether it is enabled. If the bru_enabled flag is not enabled, the method 2000 may terminate for the frame. If the bru_enabled flag is enabled, the method 2000 may read an index reference for BRU processing (bru_ref_idx) and perform BRU processing for the frame (box 2040). Optionally, prediction restrictions such as restrict_mv and restriction regions (Table 1) can be signaled at this stage.

FIG. 21 illustrates a method 2100 for processing pixel block level syntax according to an embodiment of the present disclosure. The method 2100 may be performed cooperatively with the method 2000 of FIG. 20 and it may be reached if the bru_enabled flag is set (box 2030). For each pixel block, the method 2100 may read a bru_skip flag (box 2110) and determine whether it is set (box 2110). If so, then the method 2100 may advance to the next pixel block (box 2160).

If the bru_skip flag is not set, then the method 2110 may decode partitions (box 2130) and restructure sub-blocks within the pixel block (box 2140). The method 2100 also may decode and apply in loop parameters for the pixel block (box 2150). In this regard, operations of boxes 2130-2150 may proceed as discussed in the foregoing embodiments.

The frame level and Super block level syntaxes are demonstrated in FIG. 14 (a) and (b) respectively.

Applying min_bru_size to Super Block level could also help filter signaling and latency. As shown in FIG. 21, box 2150 the codec could align the signaling of in-loop filter parameters with min_bru_size such that filter parameter signaling in the bru_skip=1 region could also be skipped.

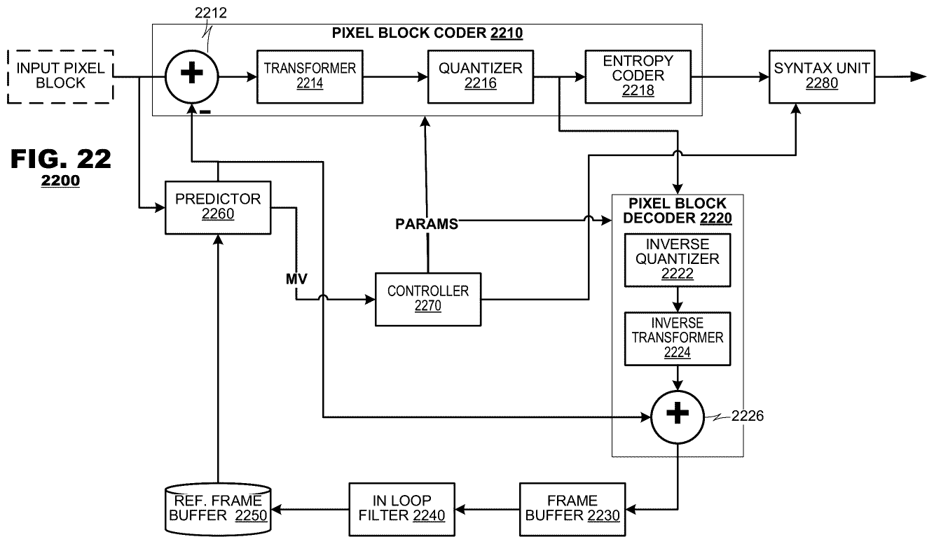

FIG. 22 is a functional block diagram of a video coder 2200 according to an aspect of the present disclosure. The video coder 2200 may operate as the video coder 230 of FIG. 2. The system 2200 may include a pixel block coder 2210, a pixel block decoder 2220, a frame buffer 2230, an in-loop filter system 2240, a reference frame buffer 2250, a predictor 2260, a controller 2270, and a syntax unit 2280.

The pixel block coder 2210 and the predictor 2260 may receive data of an input pixel block. The predictor 2260 may generate prediction data for the input pixel block and input it to the pixel block coder 2210. The pixel block coder 2210 may code the input pixel block differentially with respect to the predicted pixel block output coded pixel block data to the syntax unit 2280. The pixel block decoder 2220 may decode the coded pixel block data, also using the predicted pixel block data from the predictor 2260, and may generate decoded pixel block data therefrom.

The frame buffer 2230 may generate reconstructed frame data from decoded pixel block data. The in-loop filter 2240 may perform one or more filtering operations on the reconstructed frame. For example, the in-loop filter 2240 may perform deblocking filtering, sample adaptive offset (SAO) filtering, adaptive loop filtering (ALF), maximum likelihood (ML) based filtering schemes, deringing, debanding, sharpening, resolution scaling, and the like. The reference frame buffer 2250 may store the filtered frame, where it may be used as a source of prediction of later-received pixel blocks. The syntax unit 2280 may assemble a data stream from the coded pixel block data, which conforms to a governing coding protocol.

The pixel block coder 2210 may include a subtractor 2212, a transform unit 2214, a quantizer 2216, and an entropy coder 2218. The pixel block coder 2210 may accept pixel blocks of input data at the subtractor 2212. The subtractor 2212 may receive predicted pixel blocks from the predictor 2260 and generate an array of pixel residuals therefrom representing a difference between the input pixel block and the predicted pixel block. The transform unit 2214 may apply a transform to the sample data output from the subtractor 2212, to convert data from the pixel domain to a domain of transform coefficients. The quantizer 2216 may perform quantization of transform coefficients output by the transform unit 2214. The quantizer 2216 may be a uniform or a non-uniform quantizer. The entropy coder 2218 may reduce bandwidth of the output of the coefficient quantizer by coding the output, for example, by variable length code words or using a context adaptive binary arithmetic coder.

The transform unit 2214 may operate in a variety of transform modes as determined by the controller 2270. For example, the transform unit 2214 may apply a discrete cosine transform (DCT), a discrete sine transform (DST), a Walsh-Hadamard transform, a Haar transform, a Daubechies wavelet transform, or the like. In an aspect, the controller 2270 may select a coding mode M to be applied by the transform unit 2214, may configure the transform unit 2214 accordingly and may signal the coding mode M in the coded video data, either expressly or impliedly.

The quantizer 2216 may operate according to a quantization parameter QP that is supplied by the controller 2270. In an aspect, the quantization parameter QP may be applied to the transform coefficients as a multi-value quantization parameter, which may vary, for example, across different coefficient locations within a transform-domain pixel block. Thus, the quantization parameter QP may be provided as a quantization parameters array.

The entropy coder 2218, as its name implies, may perform entropy coding of data output from the quantizer 2216. For example, the entropy coder 2218 may perform run length coding, Huffman coding, Golomb coding, Context Adaptive Binary Arithmetic Coding, and the like.

The pixel block decoder 2220 may invert coding operations of the pixel block coder 2210. For example, the pixel block decoder 2220 may include a dequantizer 2222, an inverse transform unit 2224, and an adder 2226. The pixel block decoder 2220 may take its input data from an output of the quantizer 2216. Although permissible, the pixel block decoder 2220 need not perform entropy decoding of entropy-coded data since entropy coding is a lossless event. The dequantizer 2222 may invert operations of the quantizer 2216 of the pixel block coder 2210. The dequantizer 2222 may perform uniform or non-uniform de-quantization as specified by the decoded signal QP. Similarly, the inverse transform unit 2224 may invert operations of the transform unit 2214. The dequantizer 2222 and the inverse transform unit 2224 may use the same quantization parameters QP and transform mode M as their counterparts in the pixel block coder 2210. Quantization operations likely will truncate data in various respects and, therefore, data recovered by the dequantizer 2222 likely will possess coding errors when compared to the data presented to the quantizer 2216 in the pixel block coder 2210.

The adder 2226 may invert operations performed by the subtractor 2212. It may receive the same prediction pixel block from the predictor 2260 that the subtractor 2212 used in generating residual signals. The adder 2226 may add the prediction pixel block to reconstructed residual values output by the inverse transform unit 2224 and may output reconstructed pixel block data.

As described, the frame buffer 2230 may assemble a reconstructed frame from the output of the pixel block decoders 2220. The in-loop filter 2240 may perform various filtering operations on recovered pixel block data. For example, the in-loop filter 2240 may include a deblocking filter, a sample adaptive offset (“SAO”) filter, and/or other types of in-loop filters (not shown).

The reference frame buffer 2250 may store filtered frame data for use in later predictions of other pixel blocks. Different types of prediction data are made available to the predictor 2260 for different prediction modes. For example, for an input pixel block, intra prediction takes a prediction reference from decoded data of the same frame in which the input pixel block is located. Thus, the reference frame buffer 2250 may store decoded pixel block data of each frame as it is coded. For the same input pixel block, inter prediction may take a prediction reference from previously coded and decoded frame(s) that are designated as reference frame. Thus, the reference frame buffer 2250 may store these decoded reference frames.

The controller 2270 may control overall operation of the coding system 2200. The controller 2270 may select operational parameters for the pixel block coder 2210 and the predictor 2260 based on analyses of input pixel blocks and also external constraints, such as coding bitrate targets and other operational parameters. As is relevant to the present discussion, when it selects quantization parameters QP, the use of uniform or non-uniform quantizers, and/or the transform mode M, it may provide those parameters to the syntax unit 2280, which may include data representing those parameters in the data stream of coded video data output by the system 2200. The controller 2270 also may select between different modes of operation by which the system may generate reference images and may include metadata identifying the modes selected for each portion of coded data.

During operation, the controller 2270 may revise operational parameters of the quantizer 2216 and the transform unit 2214 at different granularities of image data, either on a per pixel block basis or on a larger granularity (for example, per tile, per slice, per largest coding unit (“LCU”) or Coding Tree Unit (CTU), or another region). In an aspect, the quantization parameters may be revised on a per-pixel basis within a coded frame.

Additionally, as discussed, the controller 2270 may control operation of the in-loop filter 2240 and the prediction unit 2260. Such control may include, for the prediction unit 2260, mode selection (lambda, modes to be tested, search windows, distortion strategies, etc.), and, for the in-loop filter 2240, selection of filter parameters, reordering parameters, weighted prediction, etc.

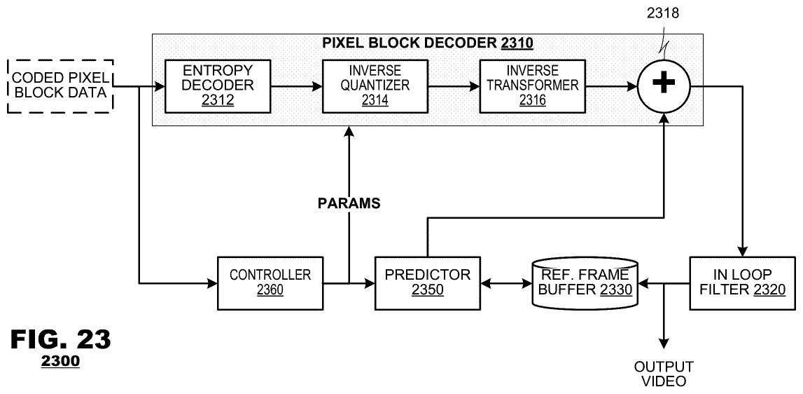

FIG. 23 is a functional block diagram of a decoding system 2300 according to an aspect of the present disclosure. The decoding system 2300 may include a pixel block decoder 2310, an in-loop filter 2320, a reference frame buffer 2330, a predictor 2350, and a controller 2360. The predictor 2350 may receive coding parameters of the coded pixel block from the controller 2360 and supply a prediction block retrieved from the reference frame buffer 2330 according to coding parameter data. The pixel block decoder 2310 may invert coding operations applied by the pixel block coder 2210 (FIG. 22). The in-loop filter 2320 may filter the reconstructed frame data. The filtered frames may be output from the decoding system 2300. Filtered frame that are designated to serve as reference tiles also may be stored in the reference frame buffer 2330.

The pixel block decoder 2310 may include an entropy decoder 2312, an inverse quantizer 2314, an inverse transformer 2316, and an adder 2318. The entropy decoder 2312 may perform entropy decoding to invert processes performed by the entropy coder 2218 (FIG. 22). The inverse quantizer 2314 may invert operations of the quantizer 2216 of the pixel block coder 2210 (FIG. 22). Similarly, the inverse transformer 2316 may invert operations of the transformer 2214 (FIG. 22). They may use the quantization parameters QP and transform modes M that are provided in the coded video data stream. Because quantization is likely to truncate data, the pixel blocks s' recovered by the inverse quantizer 2314, likely will possess coding errors when compared to the input pixel blocks presented to the pixel block coder 2210 of the encoder (FIG. 22).

The adder 2318 may invert operations performed by the subtractor 2210 (FIG. 22). It may receive a prediction pixel block from the predictor 2350 as determined by prediction references in the coded video data stream. The adder 2318 may add the prediction pixel block to reconstructed residual values output by the inverse transform unit 2316 and may output reconstructed pixel block data.

As described, the reference frame buffer 2330 may assemble a reconstructed frame from the output of the pixel block decoder 2310. The in-loop filter 2320 may perform various filtering operations on recovered pixel block data as identified by the coded video data. For example, the in-loop filter 2320 may include a deblocking filter, a sample adaptive offset (“SAO”) filter, and/or other types of in-loop filters. In this manner, operation of the reference frame buffer 2330 and the in-loop filter 2340 mimics operation of the counterpart frame buffer 2230 and in-loop filter 2240 of the encoder 2200 (FIG. 22).

The reference frame buffer 2330 may store filtered frame data for use in later prediction of other pixel blocks. The reference frame buffer 2330 may store decoded frames as it is coded for use in intra prediction. The reference frame buffer 2330 also may store decoded reference frames.

The controller 2360 may control overall operation of the coding system 2300. The controller 2360 may set operational parameters for the pixel block decoder 2310 and the predictor 2350 based on parameters received in the coded video data stream. As is relevant to the present discussion, these operational parameters may include quantization parameters QP for the dequantizer 2314 and transform modes M for the inverse transform unit 2310. As discussed, the received parameters may be set at various granularities of image data, for example, on a per pixel block basis, a per tile basis, a per slice basis, a per LCU/CTU basis, or based on other types of regions defined for the input image.

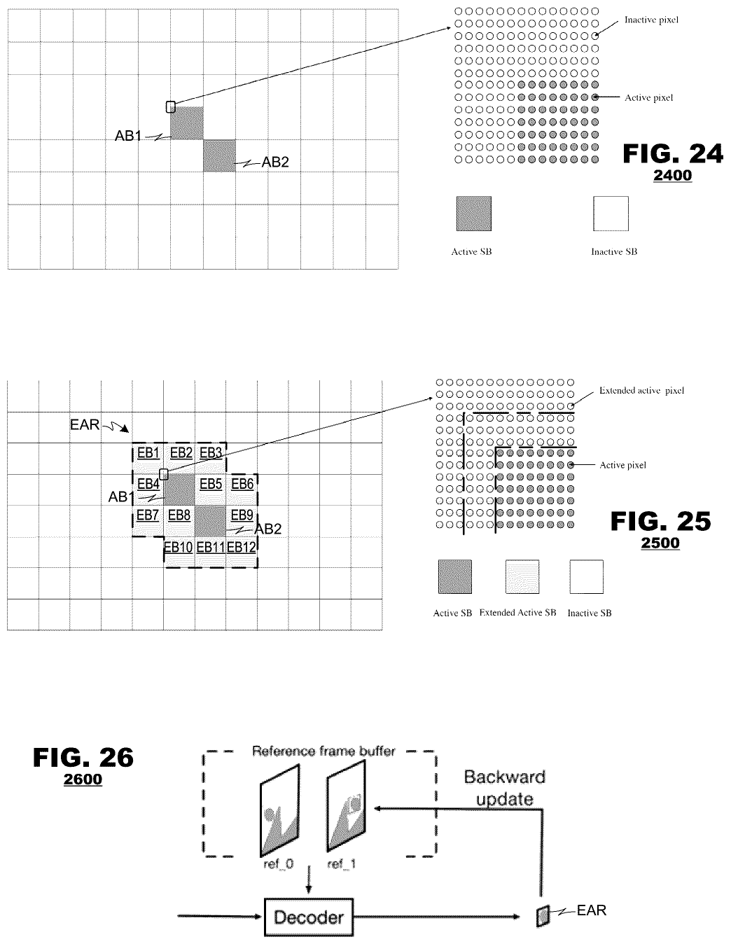

In a further embodiment, BRU replacement operations may be performed at granularities greater than an active pixel block. FIG. 24 illustrates operations of a BRU replacement operation according to one of the foregoing embodiments. This example illustrates an exemplary frame 2400 in which two pixel blocks are identified as active blocks AB1, AB2 and coded by an encoder. The remaining pixel blocks of the frame are identified as inactive blocks and need not be coded. When the BRU frame is stored to a reference frame buffer, the active blocks AB1, AB2 may overwrite corresponding pixel blocks of an already-stored reference picture, and the reference picture's picture order count (often, its “POC”) may be updated.

FIG. 25 illustrates an embodiment were an active pixel block causes an extended active region to be coded. In the embodiment of FIG. 25, an encoder may identify a frame's active blocks AB1, AB2 as in the foregoing embodiments. Thereafter, the encoder may define an extended active region (an “EAR”) that will be coded and ultimately stored to the reference picture buffer.

The EAR may be defined to extend the active region by one super block along each edge of the identified active blocks AB1, AB2. In the example of FIG. 25, the EAR would include not only active blocks AB1, AB2 but also extended blocks EB1-EB12. All blocks of the EAR, the active blocks AB1, AB2 and the extended blocks EB1-EB12 would overwrite corresponding pixel blocks of an already-stored reference picture, and the reference picture's POC may be updated.

The encoder may code the extended blocks EB1-EB12 as a special copy mode referring to the BRU reference frame, which instructs the decoder to use motion vector (0,0) for motion compensation and to skip transform and residual coding. As a result, the extended active region is just a duplication of pixels from the collocated pixels of BRU reference frame. The extended blocks' coding, therefore, involves low coding overhead.

Coding of active blocks AB1, AB2 may be performed by intra coding using content from the extended blocks EB1-EB12 as sources of prediction. In this embodiment, intra prediction and filtering restrictions may be applied across a boundary of the EAR and other inactive blocks of the frame 2500. Pixels of the extended blocks EB1-EB12 along an edge of the active blocks may be filtered as desired.

Generation of the extended blocks EB1-EB12 may consume some power in a processing system but at a reasonable level. The foregoing embodiment, however, can reduce a lot of complicated logic for processing hardware to achieve the similar efficiency. After the filtering process, the EAR may be stored to a reference picture buffer in both a decoder (FIG. 26) and an encoder (now shown) as an updated backward reference frame.

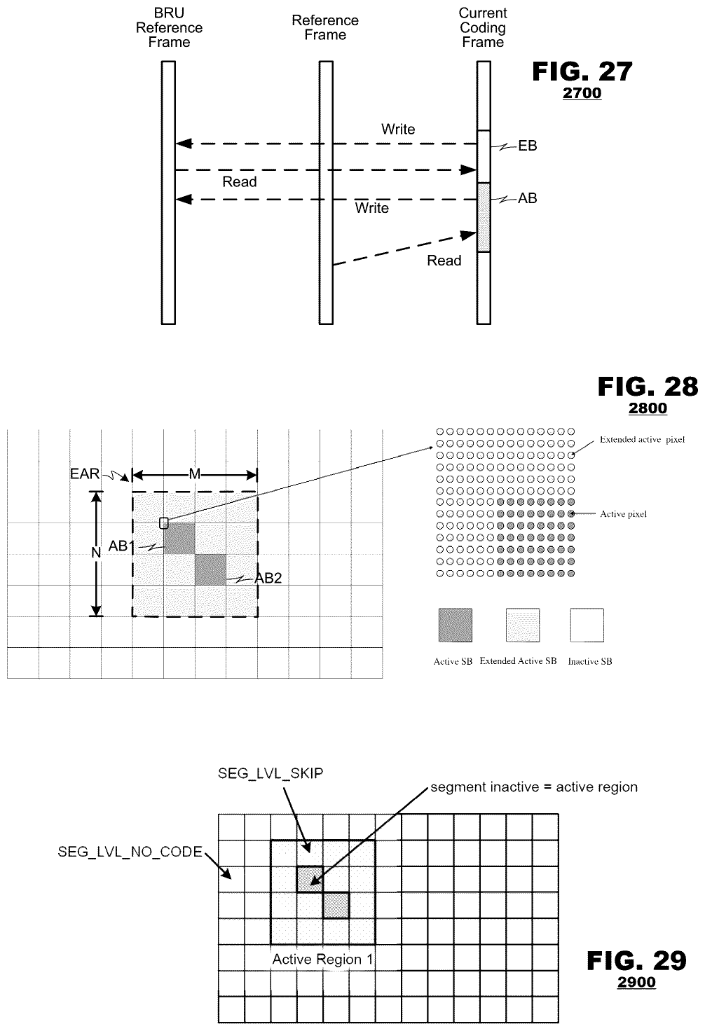

Coding operations in this embodiment may cause read and write operations to be made on a common reference frame in a reference picture buffer, which should be scheduled on pixel block bases to avoid conflict. As illustrated in FIG. 27, access to a BRU reference frame may be made to read extended block EB data as the copy mode. A write to the BRU reference frame may be made to the BRU reference frame at a later time, after decode of the active block AB is performed. By appropriately staggering the read and write operations to the BRU reference frame, conflicts between the read and write operations may be avoided. Coding/decoding operations involving other reference frame(s) in the reference picture buffer will involve only read operations and, therefore, there is no concern that a conflicting write operation might be performed on those reference frame(s).

In a further embodiment, illustrated in FIG. 28, an EAR may be defined as a rectangular region of pixel blocks that is sufficient to provide at least one buffer pixel block between the edge of any active block (say, AB1 or AB2) within the EAR and a boundary edge of the EAR. Such an embodiment provides increased leverage implementation hardness or ready utilization in sub-frame/tile schemes. In this manner, all pixel blocks contained with the M×N rectangular region of the EAR that are not active blocks would be designated extended blocks. Coding of the active blocks AB1, AB2 and the extended blocks (and, optionally, filtering) may occur as described above with respect to FIG. 25.

The following discussion provides an exemplary syntax that may be exchanged between encoders and decoders when communication information regarding EARs:

A sequence level seq_bru_enabled flag may be signaled in the sequence header open bitstream unit (“OBU”) to indicate if the BRU scheme are used in decoding this sequence.

At a frame level, A decoder may parse the bru_frame_enabled flag from the sequence level first. If bru_frame_enabled=0, no further BRU parsing will be performed, and the current frame is not a BRU frame. If bru_frame_enabled=1, bru_ref_idx, which indicates which reference frame is used for updating.

The signaling of active region may vary depending on the application. One example is to signal bru_active at super block level at the beginning of parsing the super block syntax.

An alternative solution is signaling the active region at frame level. One codec could signal total number of active super blocks first, and offsets (x, y) of each signal block. In this case, extended active super block can be viewed as active super block. Extra mode information should be signaled to indicate which active super block is extended active super block which is decoded by direct copy mode.

The inference of extended active region could also be affected by in-loop filter. If the in-loop filter is turned off on sequence level or frame level, the extended active super block could be automatically removed such that only active super block is necessary. Of course, in this case all the intra prediction restrictions addressed in previous section will be applied.

There could be many ways to signal offsets of active super block. Raster scan order super block index or absolute locations of super block are the options. An alternative method is to cluster the active regions into spatially closed groups or sub-frames, and signal the group location and each active super block offsets within the group. The codec could also use temporal information to predict current active super block location from previously decoded super block location from previous frame.

To reduce signaling overhead, a codec could also employ implicit signaling for extended block(s), meaning information of the extended block(s) may be derived from data of an active super block. For example, in an embodiment where an EAR is defined by providing an extended block on edges of active blocks (FIG. 25), locations of the extended block(s) may be derived from locations of the active block. In an embodiment that employs rectangularly shaped EAR as shown in FIG. 28, an encoder could signal a location of the EAR first and signal offsets of active blocks with respect the EAR's location. All other blocks in the EAR's region that are not explicitly signaled as ‘active’ will be inferred to be ‘extended active’.

In another variation, the BRU technique can be implemented as a special case of crop mode on the coding frame. In this embodiment, the isolated active regions may be defined as different crops in the frame. The codecs will code only the active crops. Thus, in this embodiment, a coded bitstream should consist of a group of crops which could be decoded sequentially or in parallel. All the crops in a current coding frame may have the same set of reference frame buffers. After the pixels of reconstructed crops are ready, the decoded crops may be updated by pasting or overlaying onto an existing BRU reference frame.

In yet another variation, shown in FIG. 29, coders and decoders could extend the segmentation idea to implement BRU. In this case, a SEG_LVL_NO_CODE may indicate an inactive super block. SEG_LVL_SKIP marks the extended active region which will be coded using a copy mode. For the actual active blocks, segmentation may by turned off such that the active blocks are coded using regular coding tools. In this embodiment, the updating process will update both SEG_LVL_SKIP regions and segment turned off regions.

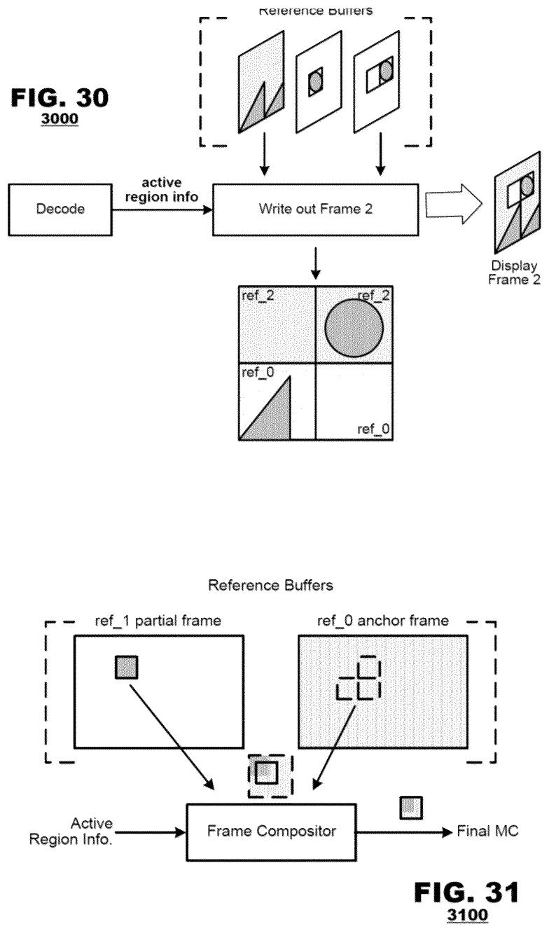

In an embodiment, a simplified BRU algorithm can be implemented by defining an anchor frame, which is not a BRU frame. In this embodiment, an example of which is shown in FIG. 30, active regions (as well as extended active regions) of a frame 3000 may be detected by comparing a current coding frame to a selected anchor frame. As a result, any output frame can be represented by a reconstructed anchor frame with the current active frame. In the example of FIG. 30, a decoder outputs current frame 2 by a write operation that combines content of an anchor reference frame (ref_0) in a reference picture buffer and a current partial reconstructed frame (ref_2).

Defining an anchor reference frame and manipulating such combinations can provide advantages in coder/decoder systems. In the encoder and decoder, there is no ‘backward update’ scheme that requires an update and, thereby, consumption of a reference frame. In backward updates processes, a ‘refresh’ of a reference frame represents an operation that logically drops the BRU reference frame from the reference frame buffer pool and assigns its updated variant as a new reference frame. The anchor frame technique can improve coding efficiency because the number of available reference frames is greater than in the ordinary BRU process. Another advantage arises because the ‘updating’ operation is removed, in which case maintenance of the reference frame buffer is different than in codecs that do not support BRU techniques.

In this scheme, as shown in FIG. 31, a frame compositor combines content from the anchor frame and a partial frame (BRU frame) into a complete reference pixels. Since the active regions in the current coding frame are generated as a result of comparing the current frame to be coded with an anchor frame (a non-BRU frame), the worst case of combination requires fetching from two reference frames with four super blocks total.

Another simplification of BRU involves copying an entire inactive region frame BRU reference frame as the current frame before coding current frame (i.e. treat all the inactive region as extended active region) and superimposing coded active blocks upon it.

The foregoing discussion has described operation of the aspects of the present disclosure in the context of video coders and decoders. Commonly, these components are provided as electronic devices. Video decoders and/or controllers can be embodied in integrated circuits, such as application specific integrated circuits, field programmable gate arrays, and/or digital signal processors. Alternatively, they can be embodied in computer programs that execute on camera devices, personal computers, notebook computers, tablet computers, smartphones, or computer servers. Such computer programs typically are stored in physical storage media such as electronic-, magnetic-, and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

Video coders and decoders may exchange video through channels in a variety of ways. They may communicate with each other via communication and/or computer networks as illustrated in FIG. 1. In still other applications, video coders may output video data to storage devices, such as electrical, magnetic and/or optical storage media, which may be provided to decoders sometime later. In such applications, the decoders may retrieve the coded video data from the storage devices and decode it.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method, comprising:
determining location(s) of an input frame to be coded that changes with respect to a reference frame stored in a reference frame buffer,
for at least one determined location:
coding a pixel block at the determined location by video compression,
decoding the coded pixel block, and
overwriting content of the stored reference frame with the decoded pixel block.

2. The method of claim 1, further comprising skip coding pixel block(s) corresponding to location(s) of the input frame that does not change with respect to the previously coded frame.

3. The method of claim 1, further comprising repeating the coding, decoding and overwriting for all determined locations of the input frame.

4. The method of claim 3, further comprising performing in loop filtering upon the stored reference frame after all determined locations are processed.

5. The method of claim 4, wherein the in loop filtering is performed at boundar (ies) between adjacent pairs of decoded pixel blocks.

6. The method of claim 4, wherein the in loop filtering is performed at boundar (ies) between a decoded pixel block and an inactive region from the stored reference frame.

7. The method of claim 3, further comprising performing in loop filtering upon each overwritten portion of the stored reference frame after each iteration of decoding.

8. The method of claim 3, further comprising:
outputting data of the coded pixel block from an encoder in a coded video stream, and
providing, in a syntactic element of the coded video stream, an identifier of a minimum pixel block size at which the coding, decoding and overwriting occurs.

9. The method of claim 1, further comprising performing filtering upon a sub-region of frame data that includes the decoded pixel block using filter parameters that reference only frame locations within the frame sub-region.

10. The method of claim 1, wherein the overwriting evicts the previously stored reference frame from a pool of candidate reference frames.

11. The method of claim 1, wherein a new reference frame corresponding to the coded pixel block is added to a pool of candidate reference frames.

12. The method of claim 1, further comprising:
outputting data of the coded pixel block from an encoder in a coded video stream, and
providing a flag in the coded video stream that indicates whether a backward refresh technique is enabled.

13. The method of claim 12, wherein the flag is provided in a frame-level syntactic element of the coded video stream.

14. The method of claim 12, wherein the flag is provided in a slice-level syntactic element of the coded video stream.

15. The method of claim 12, wherein the flag is provided in a tile-level syntactic element of the coded video stream.

16. The method of claim 12, wherein the flag is provided in a syntactic element of the coded video stream at a level higher than the pixel block in a coding hierarchy, the level being identified in its own syntactic element of the coded video stream.

17. The method of claim 1, further comprising:
outputting data of the coded pixel block from an encoder in a coded video stream, and
providing an identifier of a loop filter parameter in a syntactic element of the coded video stream.

18. The method of claim 1, wherein the coding comprises coding the pixel block differentially with respect to predicted pixel block, the predicted pixel block having originated from a prediction source other than the stored reference frame.

19. The method of claim 18, wherein the prediction source is an oldest reference frame stored in a reference frame buffer of an encoder.

20. The method of claim 18, further comprising selecting the prediction source based on a restriction criterion.

21. The method of claim 20, wherein the restriction criterion is based on a coding quality applied to candidate prediction sources.

22. The method of claim 20, wherein the restriction criterion prevents the stored reference frame to which content is overwritten from being the selected prediction source.

23. The method of claim 20, wherein the restriction criterion is based on an estimated pipeline processing characteristic.

24. The method of claim 20, wherein the restriction criterion limits a prediction source to inactive region(s) of the stored reference frame.

25. The method of claim 1, further comprising, when a decoded pixel block is on a frame boundary, generating padded frame content, from the decoded pixel block.

26. The method of claim 1, wherein the determining compares the input frame to the stored reference frame.

27. The method of claim 1, further comprising, for pixel block(s) spatially adjacent to a pixel block determined to have changed with respect to the reference frame,
coding the adjacent pixel block(s) as extended blocks,
decoding the coded extended block, and
overwriting content of the stored reference frame with the decoded extended block.

28. The method of claim 27, wherein the coding as extended blocks comprises copying content for the extended block(s) respectively from the reference frame and skipping transform and residual coding.

29. The method of claim 27, wherein the coding of at least one pixel block of the input frame that changes with respect to the reference frame comprises intra coding the at least one pixel block with reference to a decoded extended block.

30. The method of claim 27, wherein the decoding of the coded extended block comprises filtering recovered pixels of the extended block with respect to recovered pixels of the decoded coded pixel block.

31. A method, comprising:
responsive to a flag provided in coded pixel block data:
decoding coded data of pixel block, and
overwriting content of a previously stored reference frame with the decoded pixel block.

32. The method of claim 31, wherein the overwriting evicts the previously stored reference frame from a pool of candidate reference frames.

33. The method of claim 31, wherein a new reference frame corresponding to the decoded pixel block is added to a pool of candidate reference frames.

34. The method of claim 31, further comprising repeating the decoding and overwriting for all coded pixel blocks of a coded frame.

35. The method of claim 34, further comprising performing in loop filtering upon the stored reference frame after all determined locations are processed.

36. The method of claim 35, wherein the in loop filtering is performed at boundar (ies) between adjacent pairs of decoded pixel blocks.

37. The method of claim 35, wherein the in loop filtering is performed at boundar (ies) between a decoded pixel block and an inactive region from the stored reference frame.

38. The method of claim 34, further comprising performing in loop filtering upon each overwritten portion of the stored reference frame after each iteration of decoding.

39. The method of claim 31, wherein the decoding comprises decoding the pixel block differentially with respect to predicted pixel block, the predicted pixel block having originated from a prediction source other than the stored reference frame.

40. The method of claim 39, wherein the prediction source is an oldest reference frame stored in a reference frame buffer of a decoder.

41. The method of claim 31, further comprising, when a decoded pixel block is on a frame boundary, generating padded frame content, from the decoded pixel block.

42. The method of claim 1, further comprising, for pixel block(s) spatially adjacent to the pixel block identified by the flag:
decoding the adjacent pixel block(s) as extended blocks,
decoding the coded extended block(s), and
overwriting content of the stored reference frame with the decoded extended block(s).

43. The method of claim 27, wherein the decoding as extended blocks comprises copying content for the extended block(s) respectively from the reference frame and skipping transform and residual coding.

44. The method of claim 27, wherein the decoding of the pixel block identified by the flag comprises intra decoding the identified pixel block with reference to a decoded extended block.

45. The method of claim 27, wherein the decoding of the coded extended block comprises filtering recovered pixels of the extended block with respect to recovered pixels of the decoded coded pixel block.
